(19) United States
(12) Patent Application Publication
(10) Pub. No.: US 2025/0065275 A1
(43) Pub. Date: Feb. 27, 2025

(54) COMPOSITE SEMIPERMEABLE MEMBRANE

(71) Applicant: TORAY INDUSTRIES, INC., Tokyo (JP)

(72) Inventors: Shinya MITSUI, Otsu-shi (JP); Kumiko OGAWA, Otsu-shi (JP); Izumi NAGANO, Otsu-shi (JP); Harutoki SHIMURA, Otsu-shi (JP)

(73) Assignee: TORAY INDUSTRIES, INC., Tokyo (JP)

(21) Appl. No.: 18/724,808

(22) PCT Filed: Dec. 26, 2022
(86) PCT No.: PCT/JP2022/047975

§ 371 Date: Jun. 27, 2024

(30) Foreign Application Priority Data
Dec. 28, 2021 (JP) 2021-213663
Feb. 28, 2022 (JP) 2022-030301
Feb. 28, 2022 (JP) 2022-030302

(51) Int. Cl. B01D 67/00; B01D 69/10; B01D 71/56; C02F 1/44; C02F 103/08

(52) U.S. Cl. CPC B01D 67/00931; B01D 69/1071; B01D 71/56; C02F 1/44; B01D 2323/12; C02F 2103/08

(57) ABSTRACT

The present invention relates to a composite semipermeable membrane including: a microporous support layer; and a separation functional layer provided on the microporous support layer, in which the separation functional layer includes a crosslinked aromatic polyamide having a particular partial structure. The separation functional layer may have a ratio of (molar equivalent of amino groups+molar equivalent of carboxy groups)/(molar equivalent of amide groups) of 0.56 or less as measured by a DD-MAS-¹³C solid state NMR method.

### TECHNICAL FIELD

The present invention relates to a composite semipermeable membrane for use in liquid filtration and the like.

### BACKGROUND ART

Membranes for use in membrane separation of a liquid mixture include a microfiltration membrane, an ultrafiltration membrane, a nanofiltration membrane, a reverse osmosis membrane, and the like, and these membranes are used, for example, to obtain drinking water from water containing salt, a harmful substance, and the like, to produce ultrapure water for industrial use, to treat wastewater, or to collect a valuable material.

Most of currently commercially available reverse osmosis membranes and nanofiltration membranes are composite semipermeable membranes. The composite semipermeable membrane is a membrane having a plurality of layers, and a particularly widely used composite semipermeable membrane includes a microporous support layer and a separation functional layer containing a crosslinked aromatic polyamide obtained by a polycondensation reaction of a polyfunctional aromatic amine and a polyfunctional aromatic acid halide. These composite semipermeable membranes are required to have a high salt removal property in order to improve the water quality in use.

As a method for improving the salt removal property of the membranes, for example, there is known a post-treatment method for converting amine terminals of a crosslinked aromatic polyamide by a diazo coupling reaction or by contact with a bromine-containing free chlorine aqueous solution (Patent Literatures 1 and 2).

### CITATION LIST

### Patent Literature

Patent Literature 1: JP2007-090192A
Patent Literature 2: JP2001-259388A

### SUMMARY OF INVENTION

### Technical Problem

There is a trade-off relationship between the salt removal property and water permeability of the membrane, and particularly in a reverse osmosis membrane or a nanofiltration membrane, when the salt removal property is increased, the water permeability is greatly impaired. When the water permeability decreases, the operating pressure must be increased, which increases the operating cost.

Therefore, an object of the present invention is to provide a composite semipermeable membrane with an improved salt removal property without impairing water permeability.

### Solution to Problem

In order to achieve the above object, the present invention includes any of the following configurations [1] to [8].

[1]A composite semipermeable membrane including:
a microporous support layer; and
a separation functional layer provided on the microporous support layer, in which
the separation functional layer includes a crosslinked aromatic polyamide having a partial structure represented by the following formula (1).

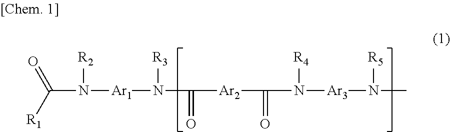

[Provided that, in the formula (1), Ar₁ to Ar₃ are each independently an aromatic ring having 5 to 14 carbon atoms that may have a substituent, R₁ represents a structure represented by any of the following formulas (2) to (4), and R₂ to R₅ are each independently a hydrogen atom or an aliphatic chain having 1 to 10 carbon atoms.]

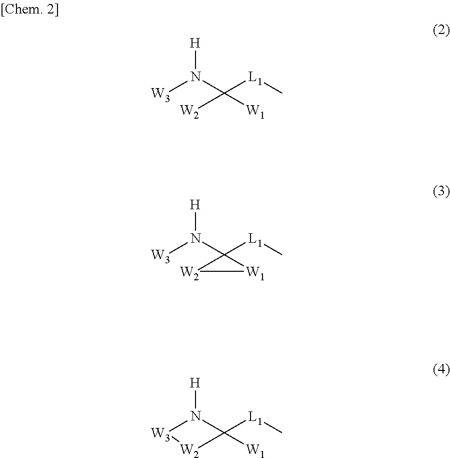

[Provided that, in the formulas (2) to (4), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group.]

[2] The composite semipermeable membrane according to [1], in which
the separation functional layer has a ratio of (molar equivalent of amino groups+molar equivalent of carboxy groups)/(molar equivalent of amide groups) of 0.56 or less as measured by a DD-MAS-¹³C solid state NMR method.

[3] The composite semipermeable membrane according to [1] or [2], in which
L₁ in the formulas (2) to (4) is a single bond.

[4] The composite semipermeable membrane according to [1] or [2], in which
W₃ in the formulas (2) to (4) is an aliphatic chain having 1 to 6 carbon atoms that may have a heteroatom or a branch.

[5] The composite semipermeable membrane according to [1] or [2], in which
R₁ in the formula (1) is represented by any of the following formulas (5) to (8).

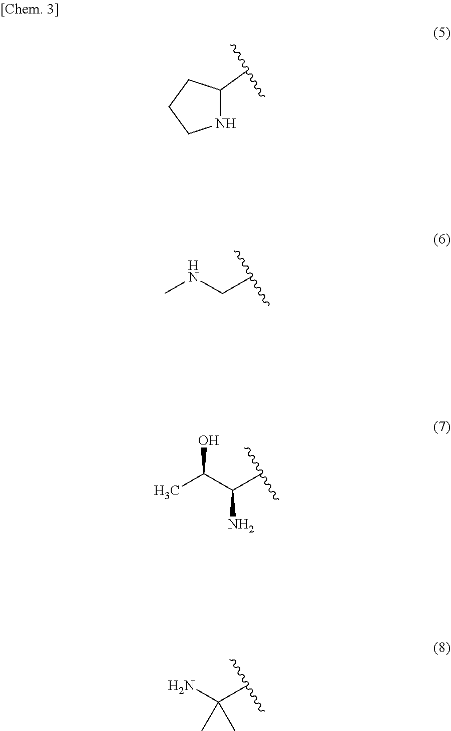

[6]A method for producing a composite semipermeable membrane, the method including:
(a) a step of forming, on a microporous support layer, a layer including a crosslinked aromatic polyamide having a partial structure represented by the following formula (9); and
(b) a step of modifying a terminal amino group in the crosslinked aromatic polyamide with an aliphatic carboxylic acid having an amino group represented by any of the following formulas (10) to (12).

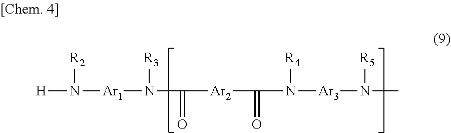

[Provided that, in the formula (9), Ar₁ to Ar₃ are each independently an aromatic ring having 5 to 14 carbon atoms that may have a substituent, and R₂ to R₅ are each independently a hydrogen atom or an aliphatic chain having 1 to 10 carbon atoms.]

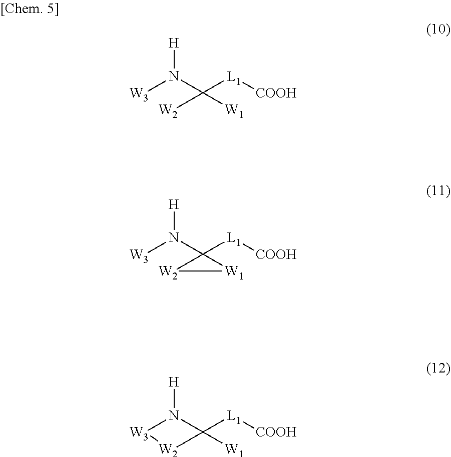

[Provided that, in the formulas (10) to (12), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group.]

[7] The method for producing a composite semipermeable membrane according to [6], in which
L₁ in the formulas (10) to (12) is a single bond.

[8] The method for producing a composite semipermeable membrane according to [6] or [7], in which
the aliphatic carboxylic acid having an amino group is at least one compound of proline, sarcosine, 2-aminoisobutyric acid, and threonine.

### Advantageous Effects of Invention

The composite semipermeable membrane according to the present invention exhibits a high salt removal property and practical water permeability.

### DESCRIPTION OF EMBODIMENTS

Hereinafter, embodiments of the present invention will be described in detail, but the present invention is not limited in any way by these embodiments. Note that, in the present description, “weight” and “mass”, and “wt %” and “mass %” are treated as synonyms.

### <1. Composite Semipermeable Membrane>

A composite semipermeable membrane according to the present embodiment includes a microporous support layer and a separation functional layer provided on the microporous support layer. A composite semipermeable membrane according to an embodiment of the present invention includes a support membrane including a substrate and a microporous support layer, and a separation functional layer formed on the microporous support layer.

The separation functional layer substantially has a separation performance, and the support membrane permeates water but substantially has no separation performance for ions or the like, and can impart strength to the separation functional layer.

### (1) Support Membrane

The composite semipermeable membrane according to the present embodiment includes a microporous support layer and a separation functional layer, and the microporous support layer is a layer that constitutes a support membrane. The support membrane includes a substrate and a microporous support layer. However, the present invention is not limited to this configuration. For example, the support membrane may be composed only of a microporous support layer without a substrate.

### (1.1) Substrate

Examples of the substrate include a polyester-based polymer, a polyamide-based polymer, a polyolefin-based polymer, and a mixture or a copolymer thereof. Among them, a fabric of a polyester-based polymer having high mechanical and thermal stability is particularly preferred. As the form of fabric, a long-fiber nonwoven fabric or a short-fiber nonwoven fabric, or a woven knitted fabric can be preferably used.

### (1.2) Microporous Support Layer

In the present embodiment, the microporous support layer has substantially no separation performance for ions or the like and is intended to impart strength to a separation functional layer substantially having a separation performance. The size and distribution of pores in the microporous support layer are not particularly limited. For example, the microporous support layer is preferably a microporous support layer having uniform and fine pores or having fine pores gradually increasing in size from a surface on which the separation functional layer is formed to the other surface, and having the size of each fine pore being 0.1 nm or more and 100 nm or less on the surface on which the separation functional layer is formed. The material used for the microporous support layer and a shape thereof are not particularly limited.

As the material for the microporous support layer, for example, homopolymers or copolymers such as a polysulfone, polyethersulfone, a polyamide, a polyester, a cellulose-based polymer, a vinyl polymer, polyphenylene sulfide, polyphenylene sulfide sulfone, polyphenylene sulfone, and a polyphenylene oxide can be used alone or in mixtures. Here, examples of the cellulose-based polymer include cellulose acetate and cellulose nitrate, and examples of the vinyl polymer include a polyethylene, a polypropylene, a polyvinyl chloride, and polyacrylonitrile.

Among them, as the material for the microporous support layer, preferred are homopolymers or copolymers such as a polysulfone, a polyamide, a polyester, cellulose acetate, cellulose nitrate, a polyvinyl chloride, polyacrylonitrile, polyphenylene sulfide, and polyphenylene sulfide sulfone, and more preferred is cellulose acetate, a polysulfone, polyphenylene sulfide sulfone, or polyphenylene sulfone. Further, a polysulfone is particularly preferred as the material for the microporous support layer because of having high chemical, mechanical, and thermal stability and being easy to mold.

The polysulfone has a weight average molecular weight (Mw) of preferably 10,000 or more and 200,000 or less, more preferably 15,000 or more and 100.000 or less when measured by gel permeation chromatography (GPC) using N-methylpyrrolidone as a solvent and a polystyrene as a standard substance.

When Mw of the polysulfone is 10,000 or more, preferred mechanical strength and heat resistance for a microporous support layer can be obtained. In addition, when Mw of the polysulfone is 200,000 or less, the viscosity of a solution is in an appropriate range, and good moldability can be realized.

For example, in the case of forming the microporous support layer using a polysulfone, a solution of the polysulfone in N,N-dimethylformamide (hereinafter referred to as DMF) is cast to a certain thickness onto a tightly woven polyester cloth or nonwoven fabric, followed by wet coagulation in water. According to this method, it is possible to obtain a microporous support layer in which most of the surface has fine pores each having a diameter of several 10 nm or less.

The thickness of the substrate and the microporous support layer influences the strength of the composite semipermeable membrane and the packing density when the composite semipermeable membrane is used as an element. In order to obtain sufficient mechanical strength and packing density, the total thickness of the substrate and the microporous support layer is preferably 30 μm or more and 300 μm or less, and more preferably 100 μm or more and 220 μm or less.

In addition, from the viewpoint of minimizing the resistance to water permeating the membrane and imparting mechanical strength to the separation functional layer, the thickness of the microporous support layer is preferably 20 μm or more and 100 μm or less, and more preferably 25 μm or more and 50 μm or less.

Note that, in this description, the thickness means an average value unless otherwise specified. The average value here represents an arithmetic average value. That is, the thickness of the substrate and the microporous support layer is obtained by calculating an average value of thicknesses at 20 points measured at an interval of 20 μm in a direction (plane direction of the membrane) orthogonal to a thickness direction in cross-sectional observation

### (2) Separation Functional Layer

The separation functional layer contains a crosslinked aromatic polyamide. In particular, the separation functional layer preferably contains a crosslinked aromatic polyamide as a main component. The main component refers to a component occupying 50 mass % or more of the components in the separation functional layer. When the separation functional layer contains 50 mass % or more of the crosslinked aromatic polyamide, a higher salt removal performance can be exhibited. In addition, the content of the crosslinked aromatic polyamide in the separation functional layer is more preferably 80 mass % or more, and still more preferably 90 mass % or more.

In the present embodiment, the crosslinked aromatic polyamide has a partial structure represented by the following formula (1) due to an amide bond via a terminal amino group thereof.

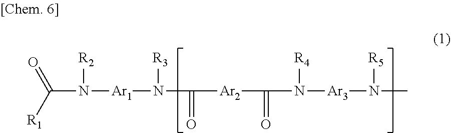

Meanings of symbols in the above formula (1) are as follows.

Ar₁ to Ar₃ are each independently an aromatic ring having 5 to 14 carbon atoms that may have a substituent.

R₁ represents a structure represented by any of the following formulas (2) to (4).

R₂ to R₅ are each independently a hydrogen atom or an aliphatic chain having 1 to 10 carbon atoms.

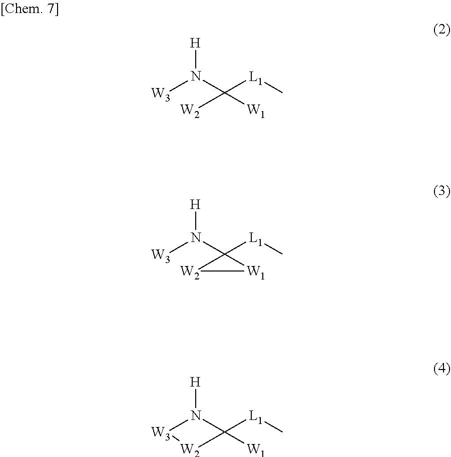

Meanings of symbols in the above formulas (2) to (4) are as follows.

L₁ is a single bond or an aliphatic chain having 1 to 6 carbon atoms.

W₁ to W₃ are each independently a hydrogen atom, or an aliphatic chain having 1 to 6 carbon atoms that may have a heteroatom or a branch, and at least one of W₁ to W₃ is an aliphatic chain having 1 to 6 carbon atoms that may have a heteroatom or a branch.

A total number of carbon atoms in W₁ and W₂ is 2 or more and 12 or less when W₃ is a hydrogen atom. W₁ to W₃ do not have a carbonyl group.

From the viewpoint of ensuring an appropriate free volume in the separation functional layer for water to permeate, Ar₁ to Ar₃ in the above formula (1) are each preferably a benzene ring that may have a substituent. Examples of the type of the substituent that the benzene ring may have include an amino group, a carboxy group, and a methyl group. Substituents other than these may also be used. In addition, the benzene ring may be unsubstituted.

From the viewpoint of forming a hydrogen bond in the crosslinked aromatic polyamide that constitutes the separation functional layer and contributing to improving the selective permeability, R₂ to R₅ in the above formula (1) are each preferably a hydrogen atom.

From the viewpoint of preventing a decrease in hydrophilicity of the crosslinked aromatic polyamide that constitutes the separation functional layer, L₁ in the above formulas (2) to (4) is preferably a single bond.

From the viewpoint of improving the water permeability of the composite semipermeable membrane, W₃ in the above formulas (2) to (4) is preferably an aliphatic chain having 1 to 6 carbon atoms that may have a heteroatom or a branch.

The crosslinked aromatic polyamide preferably contains a polyfunctional aromatic amine and a polyfunctional aromatic acid chloride as monomer components. That is, it is preferably a polycondensate of a polyfunctional aromatic amine and a polyfunctional aromatic acid chloride. Specific examples of the polyfunctional aromatic amine and polyfunctional aromatic acid chloride will be described in the section of production method.

As shown in the above formula (1), R₁ has an amino group in the structure. The hydrogen atom contained in the above amino group is a hydrogen bond donor, has high affinity with a hydrogen bond acceptor such as a carbonyl group in the crosslinked aromatic polyamide and an oxygen atom in permeated water, and contributes to formation of a continuous hydrogen bond between the crosslinked aromatic polyamide and the permeated water. Accordingly, the water permeability of the separation functional layer containing a crosslinked aromatic polyamide is enhanced.

On the other hand, when interaction between the hydrogen atom of the amino group in the structure of R₁ in the above formula (1) and the carbonyl group in the crosslinked aromatic polyamide is strong, there is a concern that pores as a path for the permeated water in the separation functional layer containing a crosslinked aromatic polyamide are clogged. However, when the amino group in the structure of R₁ in the above formula (1) is a secondary amino group, or a primary amino group in which the carbon atom adjacent to the amino group is tertiary carbon or quaternary carbon, the interaction between the amino group and the carbonyl group in the crosslinked aromatic polyamide does not become close, and a distance can be ensured. Accordingly, the clogging of the pores due to the above interaction can be prevented, and the water permeability can be ensured.

From the viewpoint of further preventing the above interaction and further improving the water permeability, the amino group in the structure of R₁ in the above formula (1) is more preferably a secondary amino group. Specifically, W₃ in the structure of R₁ in the above formula (1) is preferably an aliphatic chain having 1 to 6 carbon atoms that may have a heteroatom or a branch.

In addition, from the viewpoint of preventing the clogging of the pores due to the above interaction, in the structure of R₁ in the above formula (1), that is, W₁ to W₃ in the above formulas (2) to (4) do not have a carbonyl group.

Since an aliphatic chain is present around the amino group, when the number of carbon atoms in the aliphatic chain is large, the formation of the continuous hydrogen bond described above is inhibited. Therefore, in above formulas (2) to (4), when L₁ or W₁ to W₃ are an aliphatic chain, the number of carbon atoms is 1 to 6, preferably 1 to 2, and more preferably 1.

In addition, in above formulas (2) to (4), when W₃ is a hydrogen atom, the total number of carbon atoms in W₁ and W₂ is 2 or more and 12 or less, preferably 2 or more and 4 or less, and more preferably 2.

Specific examples of R₁ in the above formula (1) include the following formulas (5) to (8). From the viewpoint of forming a continuous hydrogen bond, R₁ in the above formula (1) is preferably represented by any of the following formulas (5) to (8).

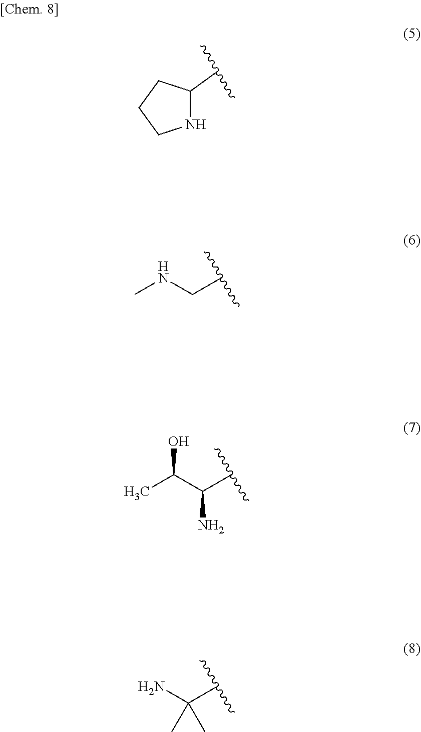

The separation functional layer preferably has a ratio of (molar equivalent of amino groups+molar equivalent of carboxy groups)/(molar equivalent of amide groups) of 0.56 or less as measured by a DD-MAS-¹³C solid state NMR method. When the ratio is 0.56 or less, the polyamide in the separation functional layer forms a dense network structure, improving a salt removal rate. The ratio is more preferably 0.50 or less, still more preferably 0.45 or less, and particularly preferably 0.42 or less. From the viewpoint of ensuring a water permeable channel in the separation functional layer, the ratio is preferably 0.30 or more, and more preferably 0.35 or more.

Examples of a method of adjusting the ratio of (molar equivalent of amino groups+molar equivalent of carboxy groups)/(molar equivalent of amide groups) in the separation functional layer include a method of polycondensing a polyfunctional aromatic amine and a polyfunctional aromatic acid chloride and then performing drying, and a method of polymerization using a polyfunctional aromatic amine aqueous solution having a high concentration and a polyfuinctional aromatic acid chloride solution having a high concentration in a polymerization step.

The amount of the functional groups in the separation functional layer can be measured by the following procedure using the DD-MAS-¹³C solid state NMR method.

When the composite semipermeable membrane includes a substrate, first, the substrate is peeled off to obtain a separation functional layer and a microporous support layer, and then the microporous support layer is dissolved and removed to obtain the separation functional layer. The obtained separation functional layer is measured by the DD/MAS-¹³C solid state NMR method, and the amount ratio of each functional group can be calculated based on a comparison with a carbon peak of each functional group or integral values of the carbon peak to which each functional group is bonded. For example, CMX-300 manufactured by Chemagnetics Inc. can be used for DD-MAS-¹³C solid state NMR measurement.

### <2. Method for Producing Composite Semipermeable Membrane>

A method for producing a composite semipermeable membrane according to the present embodiment includes a polymerization step and a modification step described below.

### (1) Polymerization Step: Step of Forming Crosslinked Aromatic Polyamide-containing Layer

The polymerization step is a step of forming, on a microporous support layer, a layer containing a crosslinked aromatic polyamide having a partial structure represented by the following formula (9).

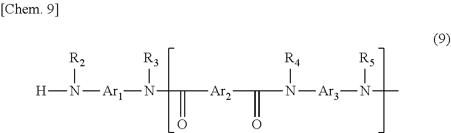

Meanings of symbols in the above formula (9) are as follows.

Ar₁ to Ar₃ are each independently an aromatic ring having 5 to 14 carbon atoms that may have a substituent.

R₂ to R₅ are each independently a hydrogen atom or an aliphatic chain having 1 to 10 carbon atoms.

Note that, preferred embodiments of each group represented by Ar₁ to Ar₃ and R₂ to R₅ in the formula (9) are the same as in the formula (1).

Specifically, the polymerization step is a step of forming a crosslinked aromatic polyamide by polycondensing a polyfunctional aromatic amine and a polyfunctional aromatic acid chloride, and more specifically, includes a step of bringing an aqueous solution containing a polyfunctional aromatic amine (hereinafter also simply referred to as a polyfunctional aromatic amine aqueous solution) into contact with a microporous support layer, and thereafter, a step of bringing an organic solvent solution containing a polyfunctional aromatic acid chloride (hereinafter also simply referred to as a polyfunctional aromatic acid chloride solution) into contact with the microporous support layer.

It is preferable that at least one of the polyfunctional aromatic amine and the polyfunctional aromatic acid chloride is trifunctional or higher. Accordingly, a rigid molecular chain is obtained and a good pore structure is formed for removing hydrated ions and fine solutes such as boron.

The polyfunctional aromatic amine is an aromatic amine having two or more amino groups of at least one of a primary amino group and a secondary amino group in one molecule, and at least one of the amino groups is a primary amino group. Examples of the polyfunctional aromatic amine include compounds having two amino groups bonded to an aromatic ring in any of the ortho position, the meta position, and the para position, such as o-phenylenediamine, m-phenylenediamine, p-phenylenediamine, o-xylylenediamine, m-xylylenediamine, p-xylylenediamine, o-diaminopyridine, m-diaminopyridine, and p-diaminopyridine, 1,3,5-triaminobenzene, 1,2,4-triaminobenzene, 3,5-diaminobenzoic acid, 3-aminobenzylamine, and 4-aminobenzylamine. One type of these polyfunctional aromatic amines may be used, or a plurality of types may be used in combination. In particular, from the viewpoint that a membrane having excellent selective separability, permeability, and heat resistance can be obtained, at least one compound of m-phenylenediamine, p-phenylenediamine and 1,3,5-triaminobenzene is preferably used as the polyfunctional aromatic amine. Among them, m-phenylenediamine is preferred because of ease of availability and handling.

The polyfunctional aromatic acid chloride is an aromatic acid chloride having at least two chlorocarbonyl groups in one molecule. Examples of a trifunctional acid chloride include trimesic acid chloride. Examples of a bifunctional acid chloride include biphenyl dicarboxylic acid dichloride, azobenzenedicarboxylic acid dichloride, terephthalic acid chloride, isophthalic acid chloride, and naphthalene dicarboxylic acid chloride. One type of these polyfunctional aromatic acid chlorides may be used, or a plurality of types may be used in combination. In particular, from the viewpoint that a membrane having excellent selective separability, permeability, and heat resistance can be obtained, a polyfunctional aromatic acid chloride having 2 to 4 carbonyl chloride groups in one molecule is preferred, and trimesic acid chloride is more preferred.

That is, the polyfunctional aromatic amine and the polyfunctional aromatic acid chloride are preferably m-phenylenediamine and trimesic acid chloride, respectively.

The concentration of the polyfunctional aromatic amine in the polyfunctional aromatic amine aqueous solution is preferably in the range of 0.1 mass % or more and 20 mass % or less, and more preferably in the range of 0.5 mass % or more and 15 mass % or less. When the concentration of the polyfunctional aromatic amine is within this range, a sufficient salt removal performance and water permeability can be obtained.

It is preferable that the contact between the polyfunctional aromatic amine aqueous solution and the microporous support layer is performed uniformly and continuously on the microporous support layer. Specifically, examples thereof include a method of coating a microporous support layer with a polyfunctional aromatic amine aqueous solution, and a method of immersing a microporous support layer in a polyfunctional aromatic amine aqueous solution. The contact time between the microporous support layer and the polyfunctional aromatic amine aqueous solution is preferably 1 second or longer and 10 minutes or shorter, and more preferably 10 seconds or longer and 3 minutes or shorter.

After the polyfunctional aromatic amine aqueous solution is brought into contact with the microporous support layer, it is preferable to remove liquids such that no droplet remains on the membrane. By removing the liquids, it is possible to prevent a liquid droplet remaining portion from becoming a membrane defect after the formation of the microporous support layer, thereby preventing the salt removal performance from decreasing. As the liquid removal method, a method of holding the support membrane after being in contact with the polyfunctional aromatic amine aqueous solution in a vertical direction and allowing the excess aqueous solution to naturally flow down, a method of forcibly removing the liquids by blowing an air flow such as nitrogen from an air nozzle, or the like can be used. In addition, after the liquid removal, the membrane surface may be dried to partially remove water from the aqueous solution.

The concentration of the polyfunctional aromatic acid chloride in the polyfunctional aromatic acid chloride solution is preferably in the range of 0.01 mass % or more and 10 mass % or less, and more preferably in the range of 0.02 mass % or more and 2.0 mass % or less. When the concentration of the polyfunctional aromatic acid chloride is 0.01 mass % or more, a sufficient reaction rate can be obtained, and when the concentration is 10 mass % or less, occurrence of a side reaction can be prevented.

The organic solvent in the polyfunctional aromatic acid chloride solution is preferably one that is immiscible with water, that dissolves the polyfunctional aromatic acid chloride, and that does not destroy the support membrane. Any material may be used as long as it is inert to the polyfunctional aromatic amine and the polyfunctional aromatic acid chloride.

Preferable examples of the organic solvent include hydrocarbon compounds such as n-nonane, n-decane, n-undecane, n-dodecane, isooctane, isodecane, and isododecane, and a mixed solvent thereof.

The contact between the polyfunctional aromatic acid chloride solution and the microporous support layer may be performed in the same manner as the method for coating the microporous support layer with the polyfunctional aromatic amine aqueous solution.

After bringing the polyfunctional aromatic acid chloride solution into contact with the microporous support layer, the membrane may be dried. By performing drying, (molar equivalent of amino groups+molar equivalent of carboxy groups)/(molar equivalent of amide groups) in the separation functional layer can be adjusted.

The drying method is not particularly limited, and the drying can be performed using, for example, an oven, a heat gun, or a hot air generator.

The temperature during the drying, that is, the temperature during the polycondensation of a polyfunctional amino and the polyfunctional aromatic acid chloride is preferably in the range of 50° C. to 100° C., more preferably in the range of 60° C. to 90° C., and still more preferably in the range of 65° C. to 90° C., from the viewpoint of appropriately adjusting (molar equivalent of amino groups+molar equivalent of carboxy groups)/(molar equivalent of amide groups) in the separation functional layer.

In addition, in order to remove excess solution remaining on the membrane surface from the membrane after the drying, the membrane may be subjected to liquid removal in the same manner as the polyfunctional aromatic amine aqueous solution. As the liquid removal method, a method using a mixed fluid of water and air can also be used other than the method mentioned for the polyfunctional aromatic amine aqueous solution.

When the polyfunctional amino and the polyfunctional aromatic acid chloride, as monomers, undergo polycondensation at an interface between the polyfunctional aromatic amine aqueous solution and the polyfunctional aromatic acid chloride solution, the crosslinked aromatic polyamide represented by the above formula (9) is generated.

Unreacted monomers can be removed by washing the membrane thus obtained with hot water. The temperature of the hot water is preferably 40° C. or higher and 100° C. or lower, and more preferably 60° C. or higher and 100° C. or lower.

Since the crosslinked aromatic polyamide-containing layer has a separation function even before the modification step described below, this layer is sometimes referred to as a separation functional layer, and a composite membrane including a substrate, a microporous support layer, and a crosslinked aromatic polyamide-containing layer is sometimes referred to as a composite semipermeable membrane.

### (2) Modification Step

The modification step is a step of modifying a terminal amino group in the crosslinked aromatic polyamide represented by the above formula (9) with an aliphatic carboxylic acid having an amino group represented by any of the following formulas (10) to (12). With this step, the structure represented by the above formula (1) is formed.

Note that, the “terminal amino group in the crosslinked aromatic polyamide represented by the formula (9)” refers to “—NHR₂” in the formula (9).

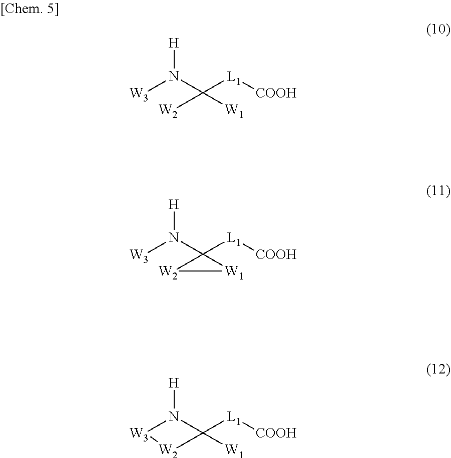

Meanings of symbols in the above formulas (10) to (12) are as follows.

L₁ is a single bond or an aliphatic chain having 1 to 6 carbon atoms.

W₁ to W₃ are each independently a hydrogen atom, or an aliphatic chain having 1 to 6 carbon atoms that may have a heteroatom or a branch, and at least one of W₁ to W₃ is an aliphatic chain having 1 to 6 carbon atoms that may have a heteroatom or a branch.

A total number of carbon atoms in W₁ and W₂ is 2 or more and 12 or less when W₃ is a hydrogen atom. W₁ to W₃ do not have a carbonyl group.

From the viewpoint of preventing a decrease in hydrophilicity of the crosslinked aromatic polyamide that constitutes the separation functional layer, L₁ in the above formulas (10) to (12) is preferably a single bond.

Note that, preferred embodiments of each group represented by W₁ to W₃ in the formulas (10) to (12) are the same as in the formula (1).

The compound represented by the formulas (10) to (12) is an aliphatic carboxylic acid having an amino group. Specific examples of the aliphatic carboxylic acid having an amino group include sarcosine, glycocyamine, N-methylalanine, N-ethylglycine, proline, azetidine-2-carboxylic acid, hydroxyproline, 3,4-dehydroproline, homoproline, serine, threonine, allothreonine, lysine, arginine, cysteine, 2-aminoisobutyric acid, 2-aminobutyric acid, valine, leucine, isoleucine, methionine, and glucosaminic acid.

Among them, from the viewpoint of forming a continuous hydrogen bond, the aliphatic carboxylic acid having an amino group is preferably at least one compound of proline, sarcosine, 2-aminoisobutyric acid, and threonine.

In the condensation reaction with the terminal amino group in the crosslinked aromatic polyamide represented by the above formula (9) (modification step), at least one compound selected from the compounds represented by the formulas (10) to (12) described above is used. These compounds may be used alone or in combination of two or more thereof.

As a method of condensing (modifying) the crosslinked aromatic polyamide represented by the above formula (9) with an aliphatic carboxylic acid having an amino group represented by any of the formulas (10) to (12) (hereinafter also referred to as an “amino group-containing aliphatic carboxylic acid”), the reaction may be carried out by coating the separation functional layer of the composite semipermeable membrane with an amino group-containing aliphatic carboxylic acid, or a composite semipermeable membrane including a separation functional layer may be immersed in an amino group-containing aliphatic carboxylic acid or a solution containing the same for reaction. Alternatively, a composite semipermeable membrane element to be described later may be prepared, and then a solution containing an amino group-containing aliphatic carboxylic acid may be passed therethrough for reaction.

The reaction time, the temperature and the concentration when coating a composite semipermeable membrane with the above amino group-containing aliphatic carboxylic acid as an aqueous solution or as it is can be adjusted as appropriate depending on the type of the amino group-containing aliphatic carboxylic acid and the coating method. For example, when the concentration of the amino group-containing aliphatic carboxylic acid is 0.1 mmol/L, the reaction time is preferably 30 minutes or longer and the reaction temperature is preferably 10° C. or higher.

In the modification step, a solution containing the above amino group-containing aliphatic carboxylic acid may be used, or a solvent-free liquid of the amino group-containing aliphatic carboxylic acid may be used. When a solution is used, the solvent can be changed depending on the type of the amino group-containing aliphatic carboxylic acid, and water or isopropanol is exemplified.

In the case of condensing the above amino group-containing aliphatic carboxylic acid, it is preferable to use various reaction aids (condensation accelerators) as necessary in order to achieve a reaction with high efficiency in a short time. Examples of the condensation accelerator include sulfuric acid, 4-(4,6-dimethoxy-1,3,5-triazin-2-yl)-4-methylmorpholinium chloride (hereinafter referred to as DMT-MM), 1-(3-dimethylaminopropyl)-3-ethylcarbodiimide hydrochloride, N,N′-dicyclohexylcarbodiimide, N,N′-diisopropylcarbodiimide, N,N′-carbonyldiimidazole, 1,1′-carbonyldi(1,2,4-triazole), 1H-benzotriazol-1-yloxytris(dimethylamino)phosphonium hexafluorophosphate, 1H-benzotriazol-1-yloxytris(dimethylamino)phosphonium hexafluorophosphate, (7-azabenzotriazol-1-yloxy)tripyrrolidinophosphonium hexafluorophosphate, chlorotripyrrolidinophosphonium hexafluorophosphate, bromotris(dimethylamino)phosphonium hexafluorophosphate, 3-(diethoxyphosphoryloxy)-1,2,3-benzotriazin-4(3H)-one, 0-(benzotriazol-1-yl)-N,N,N′,N′-tetramethyluronium hexafluorophosphate, O-(7-azabenzotriazol-l-yl)-N,N,N′,N′-tetramethyluronium hexafluorophosphate, O—(N-succinimidyl)-N,N,N′,N′-tetramethyluronium tetrafluoroborate, O—(N-succinimidyl)-N,N,N′,N′-tetramethyluronium hexafluorophosphate, O-(3,4-dihydro-4-oxo-1,2,3-benzotriazin-3-yl)-N,N,N′,N′-tetramethyluronium tetrafluoroborate, (4,6-dimethoxy-1,3,5-triazin-2-yl)-(2-octoxy-2-oxoethyl)dimethylammonium trifluoromethanesulfonate, S-(1-oxide-2-pyridyl)-N,N,N′,N′-tetramethylthiuronium tetrafluoroborate, 0-[2-oxo-1(2H)-pyridyl]-N,N,N′,N′-tetramethyluronium tetrafluoroborate, {{[(1-cyano-2-ethoxy-2-oxoethylidene)amino]oxy}-4-morpholinomethylene}dimethylammonium hexafluorophosphate, 2-chloro-1,3-dimethylimidazolinium hexafluorophosphate, 1-(chloro-1-pyrrolidinylmethylene)pyrrolidinium hexafluorophosphate, 2-fluoro-1,3-dimethylimidazolinium hexafluorophosphate, and fluoro-N,N,N′,N′-tetramethylformamidinium hexafluorophosphate.

The method for producing a composite semipermeable membrane may include, before the step of forming the separation functional layer, a step of forming a microporous support layer on a substrate to form a composite semipermeable membrane.

In addition, various post-treatments may be performed after forming the separation functional layer.

### <3. Use of Composite Semipermeable Membrane>

The composite semipermeable membrane is wound around a tubular water collection pipe in which a large number of pores are bored together with a supply water channel material such as a plastic net, a permeated water channel material such as a tricot, and a film for increasing pressure resistance as necessary, and is suitably used as a spiral type composite semipermeable membrane element. Further, the composite semipermeable membrane can also be used as a composite semipermeable membrane module in which such elements are connected in series or in parallel and accommodated in a pressure vessel.

The composite semipermeable membrane, and the element and the module thereof can constitute a fluid separation device in combination with a pump that supplies supply water thereto, a device that subjects the supply water to a pretreatment, and the like. By using this separation device, the supply water can be separated into permeated water, such as drinking water, and concentrated water, which does not permeate the membrane, to obtain intended water.

Examples of the supply water to be treated by the above composite semipermeable membrane include a liquid mixture containing 500 mg/L or more and 100 g/L or less of total dissolved solids (TDS) such as seawater, brackish water, and wastewater. In general, TDS refers to an amount of total dissolved solids and is represented by “mass÷volume” or a “weight ratio”. According to the definition, the TDS can be calculated based on a weight of a residue obtained by evaporating, at a temperature of 39.5° C. or higher and 40.5° C. or lower, a solution filtrated through a 0.45 μm filter, and is more conveniently converted from practical salinity (S).

In consideration that, as the operating pressure of the fluid separation device increases, a solute removal rate increases but energy required for the operation also increases, and in consideration of durability of the composite semipermeable membrane, the operating pressure when water to be treated permeates the composite semipermeable membrane is preferably 0.5 MPa or more and 10 MPa or less. The temperature of the supply water is preferably 5° C. or higher and 45° C. or lower since the solute removal rate decreases as the temperature increases and a membrane permeation flux decreases as the temperature decreases. In the case of supply water having a high solute concentration such as seawater, when the pH of the supply water is increased, there is a concern that scale of magnesium or the like is generated, and there is a concern that the membrane is deteriorated by a high pH operation, and thus an operation in a neutral region is preferred.

As described above, the following configuration is disclosed in the present description.

[1]A composite semipermeable membrane including:
a microporous support layer; and
a separation functional layer provided on the microporous support layer, in which
the separation functional layer includes a crosslinked aromatic polyamide having a partial structure represented by the following formula (1).

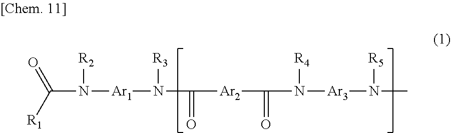

[Provided that, in the formula (1), Ar₁ to Ar₃ are each independently an aromatic ring having 5 to 14 carbon atoms that may have a substituent, R₁ represents a structure represented by any of the following formulas (2) to (4), and R₂ to R₅ are each independently a hydrogen atom or an aliphatic chain having 1 to 10 carbon atoms.]

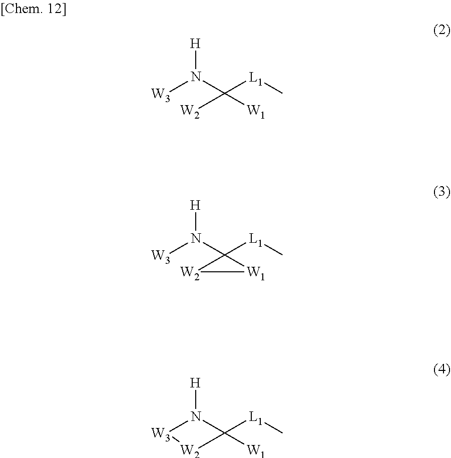

[Provided that, in the formulas (2) to (4), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group.]

[2] The composite semipermeable membrane according to [1], in which
the separation functional layer has a ratio of (molar equivalent of amino groups+molar equivalent of carboxy groups)/(molar equivalent of amide groups) of 0.56 or less as measured by a DD-MAS-¹³C solid state NMR method.

[3] The composite semipermeable membrane according to [1] or [2], in which
L₁ in the formulas (2) to (4) is a single bond.

[4] The composite semipermeable membrane according to any one of [1] to [3], in which
W₃ in the formulas (2) to (4) is an aliphatic chain having 1 to 6 carbon atoms that may have a heteroatom or a branch.

[5] The composite semipermeable membrane according to any one of [1] to [4], in which
R₁ in the formula (1) is represented by any of the following formulas (5) to (8).

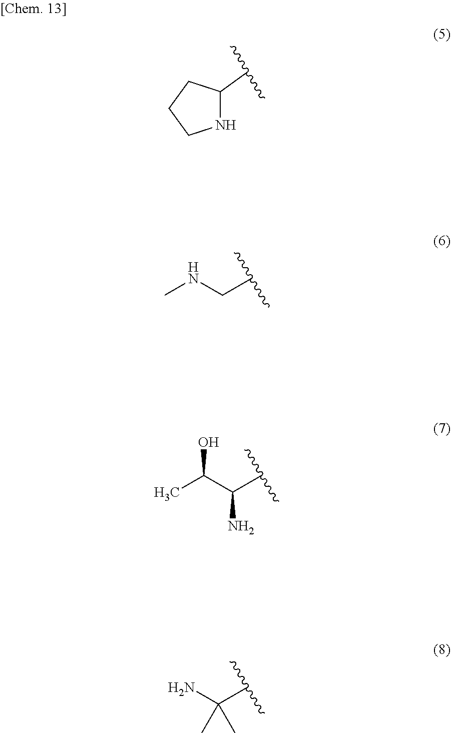

[6]A method for producing a composite semipermeable membrane, the method including:
(a) a step of forming, on a microporous support layer, a layer including a crosslinked aromatic polyamide having a partial structure represented by the following formula (9); and
(b) a step of modifying a terminal amino group in the crosslinked aromatic polyamide with an aliphatic carboxylic acid having an amino group represented by any of the following formulas (10) to (12).

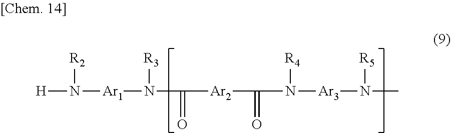

[Provided that, in the formula (9), Ar₁ to Ar₃ are each independently an aromatic ring having 5 to 14 carbon atoms that may have a substituent, and R₂ to R₅ are each independently a hydrogen atom or an aliphatic chain having 1 to 10 carbon atoms.]

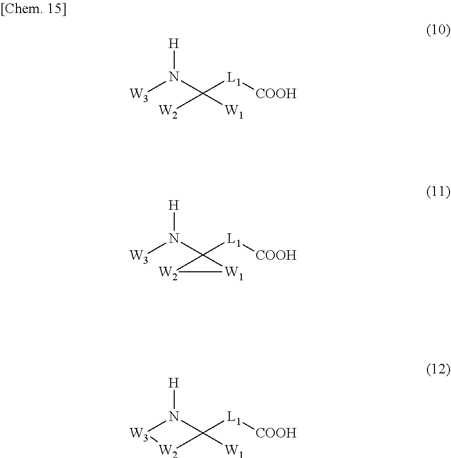

[Provided that, in the formulas (10) to (12), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group.]

[7] The method for producing a composite semipermeable membrane according to [6], in which
L₁ in the formulas (10) to (12) is a single bond.

[8] The method for producing a composite semipermeable membrane according to [6] or [7], in which
the aliphatic carboxylic acid having an amino group is at least one compound of proline, sarcosine. 2-aminoisobutyric acid, and threonine.

### EXAMPLES

Hereinafter, the present invention will be described in more detail with reference to Examples, but the present invention is not limited to these Examples. Note that, in the following, the term “composite semipermeable membrane” may be used, regardless of being before or after the modification step.

The performance evaluation of the composite semipermeable membrane obtained below was conducted as follows.

### <Performance Evaluation on Composite Semipermeable Membrane>

### (Salt Removal Rate)

Seawater (TDS concentration: 3.5%) adjusted to a temperature of 25° C. and a pH of 6.5 was supplied at an operating pressure of 5.5 MPa to obtain permeated water.

The salt removal rate was calculated based on the TDS of the obtained permeated water according to the following equation.

Salt removal rate (%)=100×{1−(TDS concentration in permeated water/TDS concentration in supply water)}

### (Membrane Permeation Flux)

The membrane permeation flux (m³/m²/day) was obtained based on a permeate amount (m³) per square meter of the membrane surface per day obtained under the above conditions.

### <Quantification of Carboxy Group, Amino Group, and Amide Group>

The substrate was physically peeled off from a 5 m² composite semipermeable membrane, and the microporous support layer and the separation functional layer were collected. The microporous support layer and the separation functional laver were allowed to stand for 24 hours for drying, and were then added little by little into a beaker containing dichloromethane, followed by stirring, to dissolve a polymer constituting the microporous support layer. An insoluble matter in the beaker was collected with filter paper. The insoluble matter was charged into a beaker containing dichloromethane, followed by stirring, to collect the insoluble matter in the beaker. This operation was repeated until elution of the polymer forming the microporous support layer in the dichloromethane solution could not be detected. The collected separation functional layer was dried in a vacuum dryer to remove the remaining dichloromethane. The obtained separation functional layer was freeze-ground into a powder sample and was sealed in a sample tube used for measurement using a solid state NMR method, and the measurement was performed by using a DD-MAS-¹³C solid state NMR method.

For the DD-MAS-¹³C solid state NMR measurement, CMX-300 manufactured by Chemagnetics Inc. was used. Measurement conditions were shown below.

Reference material: polydimethylsiloxane (internal reference: 1.56 ppm)

Sample rotation speed: 10.5 kHz

Pulse repetition time: 100 s

From the obtained spectrum, peak division was performed for each peak derived from a carbon atom to which each functional group was bonded, and the amount ratio of the functional group was determined based on the area of the peak obtained by division.

### (Preparation of Support Membrane)

A 16.0 mass % DMF solution of polysulfone UDELp-3500 manufactured by Solvay Advanced Polymers Co., Ltd. was cast to a thickness of 200 min under a condition of 25° C. on a polyester nonwoven fabric (air flow rate: 2.0 cc/cm²/sec) as a substrate. This was immediately immersed in pure water and left to stand for 5 minutes to solidify. In this way, a support membrane including a substrate and a microporous support layer was prepared. The total thickness of the substrate and the microporous support layer was 150 μm.

### Reference Example 1

The obtained support membrane was immersed for 2 minutes in a 3 mass % aqueous solution of m-phenylenediamine (m-PDA). The support membrane was slowly pulled up in a vertical direction, and nitrogen was blown through an air nozzle to remove the excessive aqueous solution from the surface of the support membrane. In an environment controlled to 40° C., a 40° C. decane solution containing 0.165 mass % of trimesic acid chloride (TMC) was applied such that the surface was completely wetted, followed by drying in an oven at 75° C. for 1 minute. Thereafter, the excessive solution was removed by holding the support membrane vertically for liquid removal. In this way, a composite semipermeable membrane in Reference Example 1 including a layer made of a crosslinked aromatic polyamide on a support membrane was obtained.

### Reference Example 2

The obtained support membrane was immersed for 2 minutes in a 3 mass % aqueous solution of m-phenylenediamine (m-PDA). The support membrane was slowly pulled up in a vertical direction, and nitrogen was blown through an air nozzle to remove the excessive aqueous solution from the surface of the support membrane. In an environment controlled to 40° C., a 40° C. decane solution containing 0.165 mass % of trimesic acid chloride (TMC) was applied such that the surface was completely wetted, followed by standing for 1 hour. Thereafter, the excessive solution was removed by holding the support membrane vertically for liquid removal. In this way, a composite semipermeable membrane in Reference Example 2 including a layer made of a crosslinked aromatic polyamide on a support membrane was obtained.

### Comparative Example 1

The composite semipermeable membrane obtained in Reference Example 1 was immersed at 25° C. for 1 hour in an aqueous solution, having a pH of 8, containing acetic acid and DMT-MM at a concentration of 100 mmol/L respectively. The obtained composite semipermeable membrane was immersed in RO water to obtain a composite semipermeable membrane in Comparative Example 1.

### Comparative Example 2

The composite semipermeable membrane obtained in Reference Example 1 was immersed at 25° C. for 1 hour in an aqueous solution, having a pH of 8, containing glycine and DMT-MM at a concentration of 100 mmol/L respectively. The obtained composite semipermeable membrane was immersed in RO water to obtain a composite semipermeable membrane in Comparative Example 2.

### Comparative Example 3

The composite semipermeable membrane obtained in Reference Example 1 was immersed at 25° C. for 1 hour in an aqueous solution, having a pH of 8, containing N,N-dimethylglycine and DMT-MM at a concentration of 100 mmol/L respectively. The obtained composite semipermeable membrane was immersed in RO water to obtain a composite semipermeable membrane in Comparative Example 3.

### Comparative Example 4

The composite semipermeable membrane obtained in Reference Example 1 was immersed at 25° C. for 1 hour in an aqueous solution, having a pH of 8, containing aceturic acid and DMT-MM at a concentration of 100 mmol/L respectively. The obtained composite semipermeable membrane was immersed in RO water to obtain a composite semipermeable membrane in Comparative Example 4.

### Example 1

The composite semipermeable membrane obtained in Reference Example 1 was immersed at 25° C. for 1 hour in an aqueous solution, having a pH of 8, containing sarcosine and DMT-MM at a concentration of 100 mmol/L respectively. The obtained composite semipermeable membrane was immersed in RO water to obtain a composite semipermeable membrane in Example 1.

### Example 2

The composite semipermeable membrane obtained in Reference Example 1 was immersed at 25° C. for 1 hour in an aqueous solution, having a pH of 8, containing proline and DMT-MM at a concentration of 100 mmol/L respectively. The obtained composite semipermeable membrane was immersed in RO water to obtain a composite semipermeable membrane in Example 2.

### Example 3

The composite semipermeable membrane obtained in Reference Example 1 was immersed at 25° C. for 1 hour in an aqueous solution, having a pH of 8, containing threonine and DMT-MM at a concentration of 100 mmol/L respectively. The obtained composite semipermeable membrane was immersed in RO water to obtain a composite semipermeable membrane in Example 3.

### Example 4

The composite semipermeable membrane obtained in Reference Example 1 was immersed at 25° C. for 1 hour in an aqueous solution, having a pH of 8, containing 2-aminoisobutyric acid and DMT-MM at a concentration of 100 mmol/L respectively. The obtained composite semipermeable membrane was immersed in RO water to obtain a composite semipermeable membrane in Example 4.

### Example 5

The composite semipermeable membrane obtained in Reference Example 1 was immersed at 25° C. for 1 hour in an aqueous solution, having a pH of 8, containing 2-aminobutyric acid and DMT-MM at a concentration of 100 mmol/L respectively. The obtained composite semipermeable membrane was immersed in RO water to obtain a composite semipermeable membrane in Example 5.

### Example 6

The composite semipermeable membrane obtained in Reference Example 1 was immersed at 25° C. for 1 hour in an aqueous solution, having a pH of 8, containing 3-aminobutyric acid and DMT-MM at a concentration of 100 mmol/L respectively. The obtained composite semipermeable membrane was immersed in RO water to obtain a composite semipermeable membrane in Example 6.

### Example 7

The composite semipermeable membrane obtained in Reference Example 2 was immersed at 25° C. for 1 hour in an aqueous solution, having a pH of 8, containing sarcosine and DMT-MM at a concentration of 100 mmol/L respectively. The obtained composite semipermeable membrane was immersed in RO water to obtain a composite semipermeable membrane in Example 7.

TABLE 1

| | | | (Molar | | |
|---|---|---|---|---|---|
| | | | equivalent | | |
| | | Type of | of amino | | |
| | | carboxylic | groups + | | Mem- |
| | | acid | molar | | brane |
| | Drying | condensed | equivalent | | per- |
| | step | to | of carboxy | | meation |
| | during | crosslinked | groups)/molar | Salt | flux |
| | membrane | aromatic | equivalent of | removal | (m³/m²/ |
| | formation | polyamide | amide groups | rate (%) | day) |
| Reference | Present | — | 0.48 | 99.83 | 0.72 |
| Example 1 | | | | | |
| Reference | Absent | — | 0.65 | 99.74 | 0.96 |
| Example 2 | | | | | |
| Comparative | Present | Acetic acid | 0.39 | 99.86 | 0.59 |
| Example 1 | | | | | |
| Comparative | Present | Glycine | 0.41 | 99.83 | 0.63 |
| Example 2 | | | | | |
| Comparative | Present | N,N- | 0.44 | 99.81 | 0.63 |
| Example 3 | | dimethyl- | | | |
| | | glycine | | | |
| Comparative | Present | Aceturic | 0.43 | 99.88 | 0.55 |
| Example 4 | | acid | | | |
| Example 1 | Present | Sarcosine | 0.43 | 99.88 | 0.68 |
| Example 2 | Present | Proline | 0.44 | 99.88 | 0.68 |
| Example 3 | Present | Threonine | 0.43 | 99.89 | 0.66 |
| Example 4 | Present | 2-Amino | 0.45 | 99.88 | 0.66 |
| | | isobutyric | | | |
| | | acid | | | |
| Example 5 | Present | 2-Amino- | 0.42 | 99.88 | 0.65 |
| | | butyric | | | |
| | | acid | | | |
| Example 6 | Present | 3-Amino- | 0.43 | 99.88 | 0.63 |
| | | butyric | | | |
| | | acid | | | |
| Example 7 | Absent | Sarcosine | 0.60 | 99.83 | 0.88 |

According to the results in Table 1, Examples 1 to 7, which are composite semipermeable membranes according to one embodiment of the present invention, exhibit an excellent salt removal property while maintaining the water permeability compared to Comparative Examples 1 to 4.

The preferred embodiments of the present invention have been described above. However, the present invention is not limited to the embodiments described above, and various modifications and substitutions can be made to the embodiments described above without departing from the scope of the present invention. The present application is based on a Japanese patent application (Japanese Patent Application No. 2021-213663) filed on Dec. 28, 2021, a Japanese patent application (Japanese Patent Application No. 2022-030301) filed on Feb. 28, 2022, and a Japanese patent application (Japanese Patent Application No. 2022-030302) filed on Feb. 28, 2022, contents of which are incorporated herein by reference.

### INDUSTRIAL APPLICABILITY

According to the present invention, it is possible to provide a composite semipermeable membrane exhibiting a high salt removal property and practical water permeability.

1. A composite semipermeable membrane comprising:
a microporous support layer; and
a separation functional layer provided on the microporous support layer, wherein
the separation functional layer comprises a crosslinked aromatic polyamide having a partial structure represented by the following formula (1), 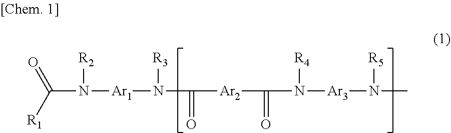
[provided that, in the formula (1), Ar₁ to Ar₃ are each independently an aromatic ring having 5 to 14 carbon atoms that may have a substituent, R₁ represents a structure represented by any of the following formulas (2) to (4), and R₂ to R₅ are each independently a hydrogen atom or an aliphatic chain having 1 to 10 carbon atoms], and 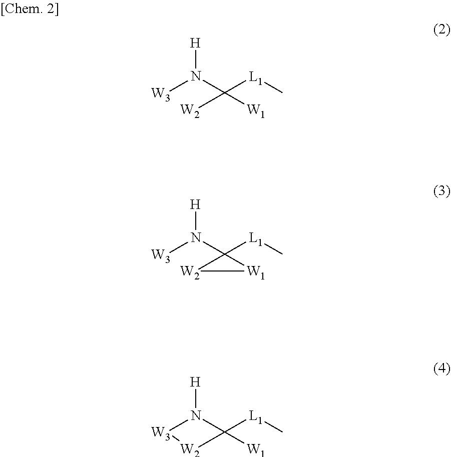
[provided that, in the formulas (2) to (4), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group].

2. The composite semipermeable membrane according to claim 1, wherein
the separation functional layer has a ratio of (molar equivalent of amino groups+molar equivalent of carboxy groups)/(molar equivalent of amide groups) of 0.56 or less as measured by a DD-MAS-¹³C solid state NMR method.

3. The composite semipermeable membrane according to claim 1, wherein
L₁ in the formulas (2) to (4) is a single bond.

4. The composite semipermeable membrane according to claim 1, wherein
W₃ in the formulas (2) to (4) is an aliphatic chain having 1 to 6 carbon atoms that may have a heteroatom or a branch.

5. The composite semipermeable membrane according to claim 1, wherein
R₁ in the formula (1) is represented by any of the following formulas (5) to (8),

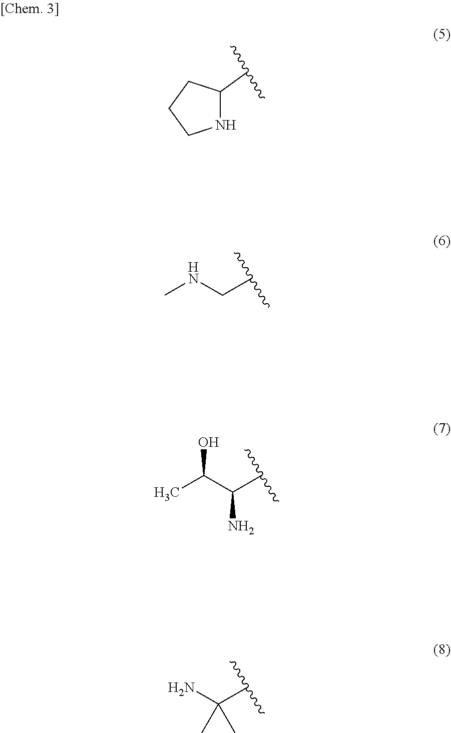

6. A method for producing a composite semipermeable membrane, the method comprising:
(a) a step of forming, on a microporous support layer, a layer comprising a crosslinked aromatic polyamide having a partial structure represented by the following formula (9); and
(b) a step of modifying a terminal amino group in the crosslinked aromatic polyamide with an aliphatic carboxylic acid having an amino group represented by any of the following formulas (10) to (12), 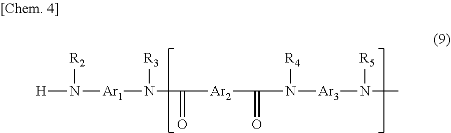
[provided that, in the formula (9), Ar₁ to A₃ are each independently an aromatic ring having 5 to 14 carbon atoms that may have a substituent, and R₂ to R₅ are each independently a hydrogen atom or an aliphatic chain having 1 to 10 carbon atoms], and 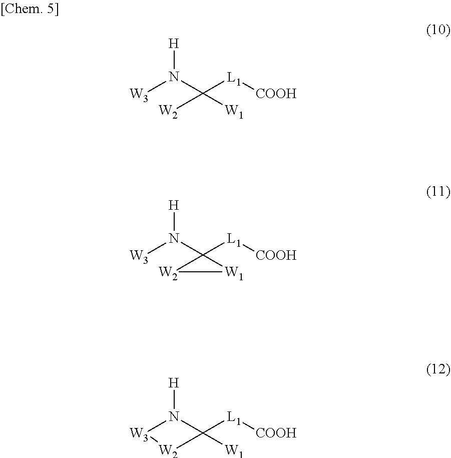
[provided that, in the formulas (10) to (12), L₁ is a single bond or an aliphatic chain having 1 to 6 carbon atoms, W₁ to W₃ are each independently a hydrogen atom, or an aliphatic chain having 1 to 6 carbon atoms that may have a heteroatom or a branch, at least one of W₁ to W₃ is an aliphatic chain having 1 to 6 carbon atoms that may have a heteroatom or a branch, a total number of carbon atoms in W₁ and W₂ is 2 or more and 12 or less when W₃ is a hydrogen atom, and W₁ to W₃ do not have a carbonyl group].

7. The method for producing a composite semipermeable membrane according to claim 6, wherein
L₁ in the formulas (10) to (12) is a single bond.

8. The method for producing a composite semipermeable membrane according to claim 6, wherein
the aliphatic carboxylic acid having an amino group is at least one compound of proline, sarcosine, 2-aminoisobutyric acid, and threonine.
